(19) United States
(12) Patent Application Publication
(10) Pub. No.: US 2012/0230396 A1
(43) Pub. Date: Sep. 13, 2012

(54) Method for Embedding Decoding Information in Quantized Transform Coefficients

(75) Inventors: Robert A. Cohen, Somerville, MA (US); Shantanu Rane, Cambridge, MA (US); Anthony Vetro, Arlington, MA (US); Huifang Sun, Woburn, MA (US)

(73) Assignee: Mitsubishi Electric Research Laboratories, Inc., Cambridge, MA (US)

(21) Appl. No.: 13/250,972

(22) Filed: Sep. 30, 2011

Related U.S. Application Data
(60) Provisional application No. 61/451,906, filed on Mar. 11, 2011.

(51) Int. Cl. H04N 7/26

(52) U.S. Cl. 375/240.03; 375/E07.139

(57) ABSTRACT

A method decodes a picture in a form of a bit-stream. The picture is encoded and represented by vectors of coefficients. Each coefficient is in a quantized form. A specific coefficient is selected in each vector based on a scan order of the vector. Then, a set of modes is inferred based on characteristics of the specific coefficient. Subsequently, the bit-stream is decoded according to the set of modes.

### RELATED APPLICATIONS

This Non-Provisional patent application claims priority to Provisional Patent Application 61/451,906, “Method for Embedding Information in Quantized Transform Coefficients” filed by Robert A. Cohen on Mar. 11, 2011, incorporated herein by reference.

### FIELD OF THE INVENTION

This invention relates generally to coding pictures, and more particularly to decoding pictures using modifying quantized transform coefficients so to an operation of the decoding can be inferred based on characteristics of the modified coefficients.

### BACKGROUND OF THE INVENTION

When pictures, videos, images, or other similar data are compressed into a bit-stream using different modes, the mode information is typically stored in a header field of the bit-stream so that a decoder will know what mode to use before the decoder applies the mode during decoding the subsequent data.

In a typical video or image compression system, the decoder receives quantized transform coefficients parsed by an entropy decoder. These quantized transform coefficients are then passed to an inverse transform. The inversed transform data are then used in various ways to reconstruct the original signal. The quantizer, transform, and subsequent decoding operations may depend upon various mode indicators that were received in header data also parsed from the entropy decoder, prior to decoding the quantized transform coefficients.

When additional mode signals are desired in a coding system, the signals can cause the size of the bit-stream used to represent the coded signals to increase. Also, if the coding system is subject to previously agreed standards or specifications, the specifications will need to be changed in order to accommodate the additional indicators.

There is a need for a method of implicitly signaling mode information in a way that reduces the size of the bit-stream than if the mode was signaled explicitly.

There is also a need for a method of signaling mode information so that the resulting bit-stream can be decoded using a previously defined bit-stream syntax. In order for this method to be practical, there is also a need to limit the complexity increase associated with using the bit-stream in an encoder or decoder. Generally, in the art, an encoder and decoder are known as a “codec.”

Encoder:

A block or vector of data is input to a transform. The output of the transform is a block or vector of transform coefficients. These transform coefficients are then passed through a quantizer, which quantizes the coefficients in a particular order. The quantized transform coefficients are then input to an entropy coder, which converts them to a binary bit-stream for transmission or storage. Various modes can be used during this process to select the transform type, quantizer type, or other modes.

Decoder:

A binary bit-stream is decoded, resulting in various mode data and a block or vector of transform coefficients. The coefficients are passed to an inverse transform, whose output is used in various ways to reconstruct the video, image, or other data. The decoded mode data are used to control different aspects of the decoding process.

Watermarking and Data Hiding:

In some video applications, a visible or invisible digital watermark is added as digital data to a picture, or a video. Watermarking is typically used to authenticate the recorded media. Such watermarks are commonly designed to be difficult to detect or remove from the picture or video. Watermarking does not increase the coding efficiency of video codecs, as desired by the present invention, and the direct application of prior art watermarking techniques for the purpose of improved coding efficiency of video is not obvious. There does exist prior art that embeds coding mode data. Typically, the prior art uses the parity (odd or even) of the sum of the absolute values of the decoded transform coefficients to decide which of two or more modes to use.

### SUMMARY OF THE INVENTION

A method decodes a picture in a form of a bit-stream. The picture is encoded and represented by vectors of coefficients. Each coefficient is in a quantized form.

A specific coefficient is selected in each vector based on a scan order of the vector. Then, a set of modes is inferred based on characteristics of the specific coefficient. Subsequently, the bit-stream is decoded according to the set of modes.

In one embodiment, the set of modes is inferred from a last-scanned non-zero coefficient.

### BRIEF DESCRIPTION OF THE DRAWINGS

FIG. 1 is a block diagram of a decoder of a codec that uses embodiments of the invention;

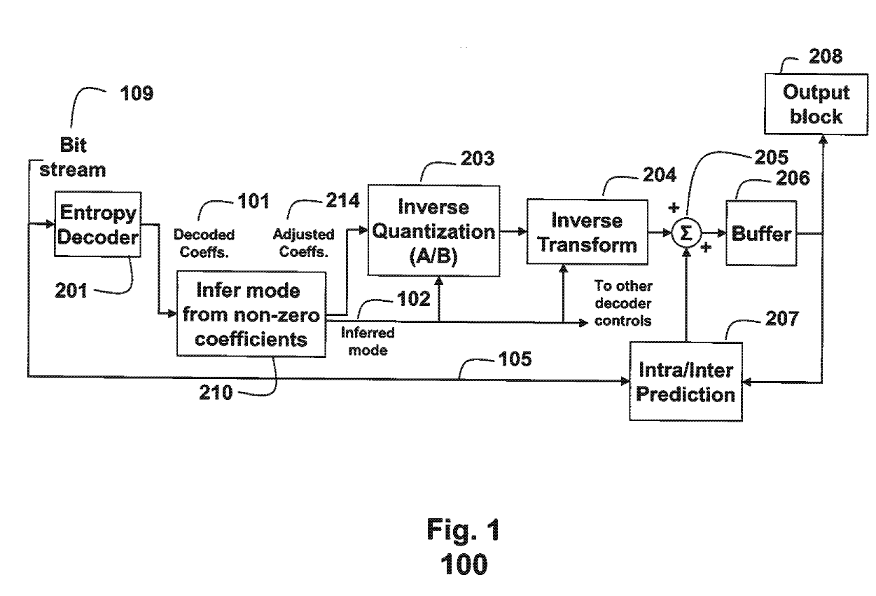

FIG. 2 is a block diagram of a mode inference module according to embodiments of the invention; and

FIGS. 3A-3D are example scan orders.

### DETAILED DESCRIPTION OF THE INVENTION

The embodiments of our invention decode a picture in a form of a bit-stream 109. The picture is partitioned into blocks and encoded. Each block is represented by a vector of coefficients. The coefficients in the block are in a quantized form.

In a decoder 100 of a codec, an entropy decoder 201 parses the bit-stream 109 and outputs a vector or block of N (previously quantized) transform coefficients 101. The bit-stream also includes inter/intra prediction data 105. A specific coefficient in each vector is selected based on a scan order of the vector. Scan orders are described below.

Block 210 infers a set of (two or more) modes based on the specific coefficient, and uses the inferred modes 102 to determine adjusted coefficients 214, as described below. Generally, the adjusted coefficients are adjusted towards zero when possible. The adjusted coefficients are inverse quantized 203 and then subject to an inverse transform 204.

Depending on the set of modes that are inferred, the inferred modes 102 can be utilized in various modules of the decoder 100. For instance, the inferred modes 102 could be used in the inverse quantization 203 and/or the inverse transform 204.

The output of the inverse transform is added 205 to the output of an intra/inter prediction module 207 and stored in a buffer 206, which eventually outputs a block 208.

The vector or block 101 is [x₀, x₁, . . . x_{N-1}]. In a typical compression system, the encoder quantizes many of the transform coefficients to zero. Hence, the focus of the invention is to select a specific coefficient among these nonzero coefficients and to infer the mode or set of modes in block 210 based on characteristics of the specific coefficient.

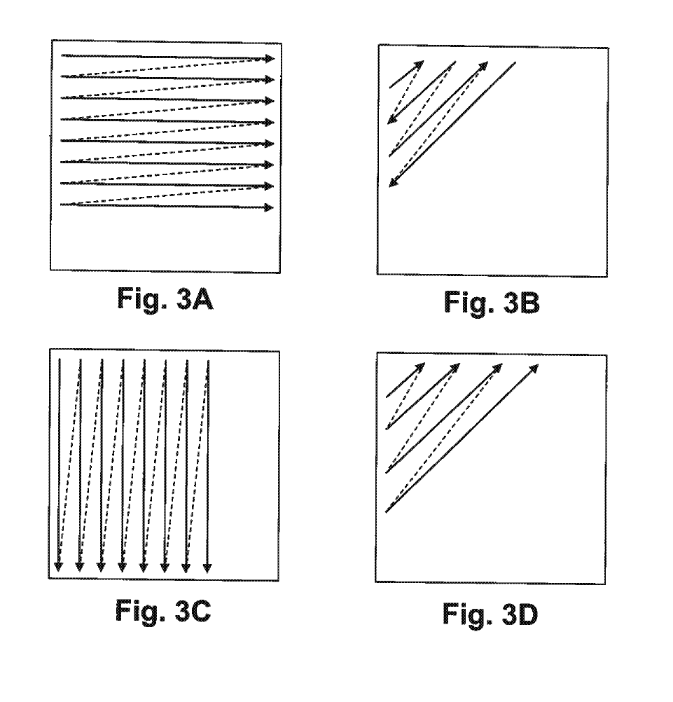

The coefficients are traversed or scanned, and then parsed in a particular order, e.g., raster scan, zigzag, vertical, diagonal up, etc. FIGS. 3A-3D show examples of different scans.

Typically, the scan order is selected to access the nonzero coefficients first, after which the remainder of quantized transform coefficients in the vector can be zero. When parsing received transform coefficients from the entropy decoder, for example, a received vector can be: [5 −3 −4 2 0 1 0 0 0 0 0 0]. In this case, element x₅ is the last nonzero coefficient.

In addition to indicating the location of the last non-zero coefficient, the location of other non-zero-coefficients can also be indicated. Furthermore, a map indicating the location of non-zero coefficients can also be derived. For the example vector given above, the binary map of non-zero coefficients can be [1 1 1 1 0 1 0 0 0 0 0 0]. Alternative tertiary-level maps may also be derived that indicate sign information, e.g., [1 −1 −1 1 0 1 0 0 0 0 0 0].

After the vector of decoded coefficients has been parsed, the mode information that was embedded in the vector can be extracted and inferred. Consider two modes “A” and “B.” For example, the decoder may use two different kinds of quantizers, two different kinds of transforms, or have some other mode that has two states. After the mode information is extracted, the decoder can then, for example, use the inverse quantizer (203) A if mode A was selected, or use an inverse quantizer B if mode B was selected. Several embodiments of extracting the embedded mode information are now described.

In the vector [x₀, x₁, . . . x_{N-1}] of N coefficients, x₀ is the first coefficient and x_{N-1} is the last coefficient. It is desired to determine the mode M that is embedded in the vector. The two possible modes, for example, are mode A and mode B.

Comparison with Prior Art

In the prior art, the mode is generally based on a parity of a sum of all of the coefficients in each block. This takes time to compute, and may not be practical in many modern real time applications, such as mobile telephone video exchanges.

The preferred embodiment of the invented decoder bases the mode on a single coefficient, and perhaps a following one. This is clearly an advantage over the prior art.

Inference Module

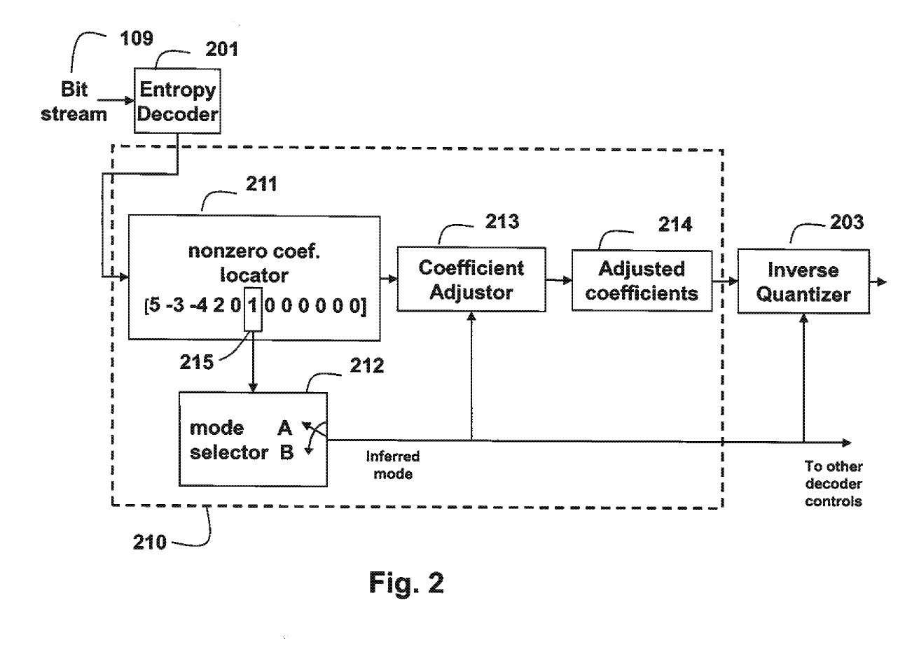

FIG. 2 shows the embodiments of the mode inference module 210. The decoded coefficients are passed to a nonzero coefficient locator module 211 so that the set of modes, e.g., A or B, can be inferred by the mode selector 212. Optionally, one of the modes in the set is then used by a coefficient adjuster module 213 to produce the adjusted coefficients 214. The adjusted coefficients are passed to the inverse quantizer 203, which may optionally be dependent upon the selected mode. The mode decision may also be used to control other parts of the decoder, such as the inverse transform 204 and the intra/inter prediction 207.

### INFERENCE MODULE EMBODIMENTS

### Embodiment 1

In this embodiment, the coefficients are scanned until the last nonzero coefficient 215 is located. If that coefficient is odd, then mode A is inferred. If that coefficient is even, then mode B is inferred. The coefficients are examined in order, to determine the last nonzero coefficient xₖ, where k may be between 0 and N−1.

If xₖ is odd, then the mode M←A.
If xₖ is even, then the mode M←B.

It is possible to swap the even and odd above, and other embodiments.

### Embodiment 2

In this embodiment, if the last coefficient is nonzero and odd in the selected scan order, then mode A is inferred, and if it is even, then mode B is inferred. If the last coefficient is zero, then the last nonzero coefficient is located. That value is considered to be a flag that indicates the mode type. If the flag is 1, then the mode is A. If the flag is −1, then the mode is B. The flag is then removed by setting that coefficient to zero. When the flag is used in this way, the decoder can recover the same set of coefficients used by the encoder (i.e., reversible), since the encoder inserts the flag at that location. If the flag is not used, because the last coefficient was adjusted in the encoder to ensure the correct mode decision was made, then that change is irreversible. The decoder embodiment is:

If the last coefficient x_{N-1} is nonzero, then:
{
If xₖ is odd, then the mode M ← A
If xₖ is even, then the mode M ← B
}
else
{
If the last coefficient x_{N-1} is zero, then the coefficients are examined in
order, to determine the last nonzero coefficient xₖ.
If xₖ = 1, then the mode M ← A, and then xₖ ← 0
If xₖ = −1, then the mode M ← B, and then xₖ ← 0
}

### Embodiment 3

Embodiment 2 can be modified so that the last coefficient may also be used as a position for the 1 or −1 flag described above:

If the last coefficient x_{N-1} is nonzero and not equal to 1 or −1, then:
{
If xₖ is odd, then the mode M ← A
If xₖ is even, then the mode M ← B
}
else
{
If the last coefficient x_{N-1} is zero or 1 or −1, then the coefficients are
examined in order, to determine the last nonzero coefficient xₖ.
If xₖ = 1, then the mode M ← A, and then xₖ ← 0
If xₖ = −1, then the mode M ← B, and then xₖ ← 0
}

### Embodiment 4

When 1 or −1 occur frequently in the encoder as the last nonzero coefficients, it may be desirable not to treat the coefficients as flags as described for other embodiments. If mode A, however, expects an even coefficient to be present, a modification is needed:

In this case, the coefficients are examined in order, to determine the last nonzero coefficient xₖ.

If xₖ is 1, −1, or even, then the mode M←A
If xₖ is odd, then the mode M←B

### Encoder Embodiments

In the encoder, the quantizer outputs a block or vector of coefficients. If the decoder, which is using one of the above embodiments, makes the correct mode decision using the coefficients, nothing special needs to be done. If, however, the values of these coefficients are such that the decoder makes an incorrect decision, the encoder must modify the coefficients before passing the coefficients to the entropy coder.

There are two ways to embed the mode data: Reversible, i.e., the modification is detected and removed in the decoder, so that the vector of coefficients in the decoder matches those of the encoder; and irreversible, wherein the decoder cannot exactly recover the exact vector after extracting the mode decision. Depending on the encoder and decoder embodiments, one or both methods, reversible and irreversible, may be employed. The vector of coefficients in the encoder is [v₀, v₁, . . . v_{N-1}].

### Encoder Embodiment 1

The coefficients are examined in order, to determine the last nonzero coefficient vₖ.

If mode M = A and vₖ is even, then:
{
If vₖ > 0 then vₖ ← vₖ − 1. This will make vₖ odd.
If vₖ < 0 then vₖ ← vₖ + 1. This will make vₖ odd.
}
If mode M = B and vₖ is odd, then:
{
If vₖ = 1 then vₖ ← 2. This will make vₖ even but not zero.
If vₖ = −1 then vₖ ← −2. This will make vₖ even but not zero.
If vₖ is neither 1 nor −1, then:
{
If vₖ > 0 then vₖ ← vₖ − 1. This will make vₖ even.
If vₖ < 0 then vₖ ← vₖ + 1. This will make vₖ even.
}
}

### Encoder Embodiment 2

If the last coefficient v_{N-1} is nonzero, then vₖ ← v_{N-1}, and then the
operations described in Encoder Embodiment 1 are performed on vₖ.
else
{
If the last coefficient v_{N-1} is zero, then the coefficients are examined
in order, to determine the last nonzero coefficient vₖ, and
{
If mode M = A, vₖ₊₁ ← 1
If mode M = B, vₖ₊₁ ← −1
}

### Encoder Embodiment 3

If the last coefficient v_{N-1} is nonzero, then vₖ ← v_{N-1}, and:
{
If mode M = A, then
{
if vₖ = −1 then vₖ ← 1; else
if vₖ is even, then vₖ is made odd by adjusting vₖ by one, toward zero,
as long as this adjustment does not make vₖ = −1. In that case, vₖ
is adjusted away from 0, i.e. vₖ = 3.
}
If mode M = B, then
{
if vₖ = 1 then vₖ ← −1; else
if vₖ is odd, then vₖ is made even by adjusting it by one, toward zero.
}
}

### Encoder Embodiment 4

Locate the last nonzero coefficient vₖ.

If mode M=B and vₖ is odd, adjust vₖ by one, toward zero. If this adjustment would make vₖ=0, then instead adjust vₖ by one, away from zero.

If mode M=A and vₖ is even, adjust vₖ by one, toward zero.

### Additional Embodiments

Instead of using the last nonzero coefficient, we use the coefficient with the largest magnitude (absolute value). If more than one coefficient has that Largest magnitude, then we use the one with the highest vector index (i.e., the last coefficient with the largest magnitudes).

Instead of using odd/even to make the decision, we use the difference between two (adjacent) coefficients. If the difference is positive, we infer mode A. If negative, we infer mode B.

The sign (positive or negative) of a given coefficient can also be used to infer the mode. The encoder can change the sign of a coefficient, and the decoder can use that sign to determine the mode. After inferring the mode, the decoder can use other information in the coefficients to decide whether to change the sign again so that the adjusted coefficients in the decoder match the original coefficients in the encoder.

For cases where the quantizer uses rate-distortion optimized quantization (RDO-Q), the embedding of the mode flag or mode information can be made part of the RDO-Q process. While deciding which coefficients to set to zero, the RDO-Q process can incorporate the cost of the mode flag in addition to the cost of the coefficients.

More than two modes can be signaled. For example, three modes A, B, and C can be signaled. Additionally, multiple sets of modes can be signaled. For example, Set 1 includes modes A, B, and C, and Set 2 includes modes W,X,Y,Z. One mode from Set 1 and one mode from Set 2 can be signaled for each set of coefficients.

Instead of using the last nonzero coefficient to signal the mode, another property, such as the largest or the smallest coefficient can be used. If more than one coefficient meets the specified criteria, then a secondary decision process can choose where to embed the information. For example, if the specified criterion is to use the largest coefficient, and two of the coefficients have the same largest value, then the last of these two coefficients can be used.

Another embodiment can determine the number of consecutive, i.e., adjacent, nonzero coefficient groupings. The group with the most nonzero coefficients can be used to embed the mode information using any of the earlier-described embodiments.

Also, as described earlier, binary or tertiary-level maps can be derived from the decoded coefficients. The mode for a block can also be inferred based on a function of these maps or patterns in the maps. For instance, the mode can be inferred based on the number of non-zero coefficients. Binary codewords could also be embedded in these maps at the encoder to signal various modes.

The invention has been described by way of examples of preferred embodiments. It is to be understood that various other adaptations and modifications may be made within the spirit and scope of the invention. Therefore, it is the object of the appended claims to cover all such variations and modifications as come within the true spirit and scope of the invention.

We claim:

1. A method for decoding a picture in a form of a bit-stream, wherein the picture is encoded and represented by vectors of coefficients, wherein each coefficient is in a quantized form, comprising the steps of:
selecting a specific coefficient in each vector based on a scan order of the vector;
inferring a set of coding modes based on characteristics of the specific coefficient; and
decoding the bit-stream according to the set of coding modes, wherein the steps are performed in a decoder.

2. The method of claim 1, wherein the set of coding modes is inferred from a last-scanned non-zero coefficient.

3. The method of claim 2, wherein a value of the last-scanned non-zero coefficient is 1 or −1.

4. The method of claim 3, further comprising:
setting the value to zero after the inferring.

5. The method of claim 2, wherein a value of the last-scanned non-zero coefficient is 1, −1, or even to infer a first coding mode, and otherwise inferring a second coding mode.

6. The method of claim 2, further comprising:
adjusting the value toward zero after the inferring.

7. The method of claim 2, further comprising:
adjusting the value away from zero if the last-scanned coefficient value is 1 or −1 before the inferring.

8. The method of claim 2, wherein a value of the last-scanned coefficient is 2 or −2, and adjusting the value away from zero if adjustment to an odd value is required.

9. The method of claim 1, wherein the specific coefficient has a largest magnitude among the vector of coefficients.

10. The method of claim 9, wherein the largest magnitude occurs in more than one coefficient.

12. The method of claim 1, wherein the set of coding modes is inferred from a sign of a difference between two coefficients.

13. The method of claim 12, wherein the sign is adjusted after the inferring.

14. The method of claim 1, wherein the set of coding modes is inferred in conjunction with a rate-distortion optimized quantization process.

16. The method of claim 1, wherein a cost is used to determine the embedding of information in the coefficients.

17. The method of claim 1, wherein the set of coding modes is inferred from a number of consecutive nonzero coefficients.

18. The method of claim 1, wherein the set of coding modes is inferred using a function applied to the coefficients.

19. The method of claim 18, wherein the function is pseudo-random.

20. The method of claim 1, wherein the set of coding modes is determined by an encoder.

21. The method of claim 1, further comprising:
indicating in a map the locations of the non-zero coefficients.

22. The method of claim 1, further comprising:
indicating in a map the sign of each non-zero coefficient.

23. The method of claim 2, further comprising:
adjusting a value of the specific coefficient away from zero after the inferring.
